(19) United States
(12) Patent Application Publication
(10) Pub. No.: US 2025/0209375 A1
(43) Pub. Date: Jun. 26, 2025

(54) METHODS, SYSTEMS, AND COMPUTER READABLE MEDIA FOR GENERATING SYNTHETIC ARTIFICIAL INTELLIGENCE (AI)-IMPLEMENTED COMPUTER NETWORK BEHAVIORAL MODEL TRAINING DATA

(71) Applicant: Keysight Technologies, Inc., Santa Rosa, CA (US)

(72) Inventors: Christian Paul Sommers, Bangor, CA (US); Peter J. Marsico, Chapel Hill, NC (US)

(21) Appl. No.: 18/422,953

(22) Filed: Jan. 25, 2024

Related U.S. Application Data
(60) Provisional application No. 63/614,367, filed on Dec. 22, 2023.

(51) Int. Cl. G06N 20/00

(52) U.S. Cl. CPC G06N 20/00

(57) ABSTRACT

A method for generating synthetic AI-implemented computer network behavioral model training data includes receiving, as input, sample AI-implemented computer network behavioral model training data or an AI-implemented computer network behavioral model training data definition, generating, based on the input, a test case definition for configuring and controlling components of an instrumented testbed environment to execute at least one network test. The method further includes executing the at least one network test within the instrumented testbed environment. The method further includes recording, network performance and operational data generated from the execution of the at least one network test. The method further includes generating, as output and based on the network performance and operational data, synthetic AI-implemented computer network behavioral model training data including at least one parameter not included or defined in the AI-implemented computer network behavioral model training data or definition.

### CROSS REFERENCE TO RELATED APPLICATIONS

This application claims the priority benefit of U.S. Provisional Patent Application Ser. No. 63/614,367 filed on Dec. 22, 2023, the disclosure of which is incorporated herein by reference in its entirety.

### TECHNICAL FIELD

The subject matter described herein relates to generating data used to train AI-implemented models. More particularly, the subject matter described herein relates to methods, systems, and computer readable media for generating synthetic AI-implemented computer network behavioral model training data.

### BACKGROUND

AI-implemented models require training data to improve quality in their output. AI-implemented models that model the behavior of computer networks are no exception. The goal of AI-implemented computer network behavioral models may be to model the behavior of a computer network, for example, for network planning, vulnerability assessment, etc.

Obtaining training data to train computer network behavioral models can present challenges. For example, one possible way to obtain computer network behavioral model training data is to tap a real or production network and use the data collected by the network taps to generate the AI model training data. Training a model based on real network data may be accurate.

However, real network data may not be sufficient in quantity or scale to train an AI-implemented mode. In addition, real network data may not include anomalous events necessary for training that are undesirable or impractical to replicate in live networks.

To overcome the limitations or impracticality associated with training an AI-implemented computer network behavioral model on data from a real public or private production network, a lab network may be used. One problem with using lab networks to generate model training data is volume. The lab network may not be able to generate a sufficient volume or amount of training data to adequately train an AI-implemented computer network behavioral model. In some cases, the lab network may not be able to collect training data with a sufficient number of dimensions to adequately train an AI-implemented computer network behavioral model. In some cases, the lab network may not be able to generate training data reflective of the actual topological scale of a network to adequately train an AI-implemented computer network behavioral model. For example, a lab network environment may only implement a subset of the actual number of elements in an envisioned/contemplated production network environment.

Simulated networks can also be used to generate AI-implemented model training data. However, the data generated is only as accurate as the simulation and may not accurately reflect real network behavior.

In light of these and other difficulties, there exists a need for improved methods, systems, and computer readable media for generating training data for AI-implemented computer network behavioral models.

### SUMMARY

A method for generating synthetic AI-implemented computer network behavioral model training data includes receiving, as input, sample AI-implemented computer network behavioral model training data or an AI-implemented computer network behavioral model training data definition. Such sample training data and/or training data definition information may, for example, include information that describes the number and types of dimensions (i.e., parameters) of the training data. The method further includes generating, based on the input, a test case definition for configuring and controlling components of an instrumented testbed environment to implement a desired network topology to execute at least one network test. The method further includes executing the at least one network test within the instrumented testbed environment. The method further includes recording network performance and operational data generated from the execution of the at least one network test. The method further includes generating, as output and based on the network performance and operational data, synthetic AI-implemented computer network behavioral model training data. The synthetic AI-implemented computer network behavioral model training data includes at least one parameter not included or defined in the AI-implemented computer network behavioral model training data or the AI-implemented computer network behavioral model training data definition.

According to another aspect of the subject matter described herein, receiving, as input, sample AI-implemented computer network behavioral model training data or an AI-implemented computer network behavioral model training data definition includes receiving the sample AI-implemented computer network behavioral model training data as input.

According to another aspect of the subject matter described herein, receiving, as input, sample AI-implemented computer network behavioral model training data or an AI-implemented computer network behavioral model training data definition includes receiving the AI-implemented computer network behavioral model training data definition as input.

According to another aspect of the subject matter described herein, receiving, as input, sample AI-implemented computer network behavioral model training data or an AI-implemented computer network behavioral model training data definition includes receiving the AI-implemented computer network behavioral model training data and/or definition content that was obtained from a live or production network.

According to another aspect of the subject matter described herein, generating the test case definition includes generating instructions for configuring the components of the instrumented testbed environment to implement a network topology.

According to another aspect of the subject matter described herein, executing the at least one network test includes transmitting network traffic within the network topology.

According to another aspect of the subject matter described herein, recording the network performance and operational data includes recording network-traffic-related statistics resulting from the execution of the at least one network test and network conditions that resulted in the generation of the network-traffic-related statistics.

According to another aspect of the subject matter described herein, generating the synthetic AI-implemented computer network behavioral model training data includes generating synthetic AI-implemented computer network behavioral model training dataset records.

According to another aspect of the subject matter described herein, the method for generating synthetic AI-implemented computer network behavioral model training data includes configuring the instrumented testbed environment to implement a network topology of a fidelity higher than a fidelity used to generate the sample AI-implemented computer network behavioral model training data.

According to another aspect of the subject matter described herein, the method for generating synthetic AI-implemented computer network behavioral model training data includes receiving, as input, scaling instructions and generating the test case definition includes using the scaling instructions to generate a network topology of a desired scale and executing the at least one network test includes executing the at least one network test in the network topology of the desired scale.

According to another aspect of the subject matter described herein the method for generating synthetic AI-implemented computer network behavioral model training data includes computing an error metric indicating a difference between the synthetic AI-implemented computer network behavioral model training data and the sample Al computer network behavioral model training data, generating at least one updated network test in response to the error metric exceeding a threshold, executing the at least one updated network test within the instrumented testbed environment, recording network performance and operational data generated by the execution of the at least one updated network test; and generating, as output and based on the network performance and operational data, updated synthetic AI-implemented computer network behavioral model training data.

According to another aspect of the subject matter described herein, a system for generating synthetic AI-implemented computer network behavioral model training data is provided. The system includes at least one processor and a memory. The system further includes an AI model training data synthesizer module implemented by the at least one processor for receiving, as input, sample AI-implemented computer network behavioral model training data or an AI-implemented computer network behavioral model training data definition and generating, based on the input, a test case definition implementing and executing at least one network test. The system further includes an instrumented testbed environment for executing the at least one network test and for recording network performance and operational data generated from the execution of the at least one network test. The AI model training data synthesizer module is configured to generate, as output and based on the network performance and operational data, synthetic AI-implemented computer network behavioral model training data. The synthetic Al implemented computer network behavioral model training data includes at least one parameter not included or defined in the AI-implemented computer network behavioral model training data or the AI-implemented computer network behavioral model training data definition.

According to another aspect of the subject matter described herein, the input includes the sample AI-implemented computer network behavioral model training data.

According to another aspect of the subject matter described herein, the input includes the AI-implemented computer network behavioral model training data definition.

According to another aspect of the subject matter described herein, in generating the test case definition, the AI model training data synthesizer module is configured to generate instructions for configuring the components and associated resources of the instrumented testbed environment to implement a network topology.

According to another aspect of the subject matter described herein, in executing the at least one network test, the instrumented testbed environment is configured to transmit network traffic within the network topology and, in recording the network performance and operational data, the instrumented testbed environment is configured to record network-traffic-related statistics resulting from the execution of the at least one network test and network conditions that resulted in the generation of the network-traffic-related statistics.

According to another aspect of the subject matter described herein, in generating the synthetic AI-implemented computer network behavioral model training data, the AI model training data synthesizer module is configured to generate synthetic AI-implemented computer network behavioral model training dataset records.

According to another aspect of the subject matter described herein, the instrumented testbed environment to implement a network topology of a fidelity higher than a fidelity used to generate the sample AI-implemented computer network behavioral model training data.

According to another aspect of the subject matter described herein, the AI model training data synthesizer module is configured to receive, as input, scaling instructions and, in generating the test case definition, the AI model training data synthesizer module is configured to use the scaling instructions to generate a network topology of a desired scale (e.g., a desired number of network elements and/or network resources, etc.) within the instrumented testbed environment and, in executing the at least one network test, the instrumented testbed environment is configured to execute the at least one network test in the network topology of the desired scale.

According to another aspect of the subject matter described herein, the AI model training data synthesizer module is configured to compute an error metric indicating a difference between the synthetic AI-implemented computer network behavioral model training data and the sample Al computer network behavioral model training data, and generate at least one updated network test in response to the error metric exceeding a threshold, the instrumented testbed environment is configured to execute the at least one updated network test and record network performance and operational data generated by the execution of the at least one updated network test, and the AI model training data synthesizer module is configured to generate, as output and based on the network performance and operational data, updated synthetic AI-implemented computer network behavioral model training data.

According to another aspect of the subject matter described herein, a non-transitory computer readable medium having stored thereon executable instructions that when executed by a processor of a computer control the computer to perform steps is provided. The steps include receiving, as input, sample AI-implemented computer network behavioral model training data or an AI-implemented computer network behavioral model training data definition. The steps further include generating, based on the input, a test case definition for configuring and controlling components of a network test/emulation system to execute at least one network test. The steps further include executing the at least one network test within the instrumented testbed environment. The steps further include recording network performance and operational data generated from the execution of the at least one network test. The steps further include generating, as output and based on the network performance and operational data, synthetic AI-implemented computer network behavioral model training data. The synthetic AI-implemented computer network behavioral model training data includes at least one parameter not included or defined in the AI-implemented computer network behavioral model training data or the AI-implemented computer network behavioral model training data definition. The subject matter described herein can be implemented in software in combination with hardware and/or firmware. For example, the subject matter described herein can be implemented in software executed by a processor.

In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Exemplary implementations of the subject matter described herein will now be explained with reference to the accompanying drawings, of which:

FIG. 1 is a block diagram of a network test/emulation system for generating synthetic AI-implemented computer network behavioral model training data in response to user input including sample model training data or a model training data definition;

FIG. 2 is a block diagram of a network test/emulation system illustrating the use of the network test/emulation system to perform AI-implemented computer network behavioral model training dataset record inflation;

FIG. 3 is a table illustrating the structure of an AI model training dataset and the addition of new records containing synthetic AI-implemented computer network behavioral model training data to the dataset;

FIG. 4 is a table illustrating exemplary AI-implemented computer network behavioral model training dataset parameters;

FIG. 5 is a block diagram of a network test/emulation system illustrating the use of the network test/emulation system to perform AI-implemented computer network behavioral model training dataset parameter inflation;

FIG. 6 is a table illustrating the addition of parameters to an existing AI-implemented computer network behavioral model training dataset;

FIG. 7 is a block diagram of a network test/emulation system illustrating the use of the network test/emulation system to generate synthetic AI-implemented computer network behavioral model training data in response to receiving scaling instructions as input;

FIG. 8 is a block diagram of a network test/emulation system illustrating the use of the network test/emulation system to self-tune or calibrate synthetic AI-implemented computer network behavioral model training data generation; and

FIG. 9 is a flow chart illustrating an exemplary process for generating synthetic AI-implemented computer network behavioral model training data.

### DETAILED DESCRIPTION

The subject matter described herein includes a network test/emulation system that is adapted to generate network configuration, network traffic and network performance data, and, from that data, generate AI model training data that can be used to train Al models (e.g., machine learning models, deep learning models, etc.) that predict network performance/behavior (e.g., that could be used for network planning purposes, network diagnostic purposes, network security purposes, etc.).

The network test/emulation system receives AI model training dataset related input from a user, analyzes or processes the input information, and configures test traffic generation and network emulation resources to generate AI model training data that may be captured during test case execution and used to supplement the user's existing AI model training dataset(s). Such data may include network topology information and collected network configuration data, topology data, operational data (e.g., switch/router queue congestion status, link utilization/congestion status data, network resource utilization, etc.), traffic data (e.g., control plane traffic types and amounts, data plane traffic amounts and types, etc.), performance metric data (e.g., packet latency, jitter, throughput capacity, memory utilization, compute resource utilization, etc.), etc.

Examples of such supplementation include, but are not limited to, generating additional records or entries that are added to a user's existing Al model training dataset(s), and generating additional parameters and associated values that are appended to the user's existing AI model training dataset(s).

In general, the subject matter described herein enables users to increase the size, diversity, and robustness of their AI model training datasets by intelligently supplementing their existing AI model training data with test system-generated synthetic training data.

The network test/emulation system described herein can be given a user's live network configuration/operational parameters, as well as the training dataset(s) that they created from live network observations (e.g., a JavaScript object notation (JSON) file, etc.), or a desired AI model training set data structure (e.g., a data structure definition/format, etc.).

The network test/emulation system described herein analyzes the provided training dataset(s) information and associated configuration/operational parameters and automatically creates an Al model training data creation plan that can be executed by the test system.

The network test/emulation system described herein uses the Al model training data creation plan to configure a testbed with various real and/or emulated resources/elements (e.g., physical DUTs, physical emulators, virtual emulators, etc.), as well as associated test case scripts that are used to generate various test traffic scenarios. The fidelity level of the test resources (i.e., emulations) chosen may be dependent/dictated by the analysis of the live-network-derived sample training dataset (or data structure information) provided by the user. For example, if it is determined that Al model supplementation data is required that includes switch/router queue congestion level information, then the test system automatically selects a switch/router emulation resource that is capable of generating and providing the desired queue congestion level metrics. More specifically, if the test system has available both a low fidelity, software-based switch emulation resource that is not capable of generating queue congestion level metrics and a high fidelity, hardware-based switch emulation resource that is capable of generating queue congestion level metrics, then the test system will select the higher-fidelity, hardware-based switch emulation resource for use in the test. As emulation resources of varying fidelity levels often have different cost profiles (i.e., higher fidelity emulation resources often have a higher cost, etc.), the ability of the test system to automatically select the appropriate/most cost effective combination of emulation resources for a given test case is advantageous.

Test traffic scenarios may include various traffic rates, traffic protocol mixes, impairments, etc. These traffic scenarios may correspond to scenarios that the user would not normally observe/be able to safely create in their live network.

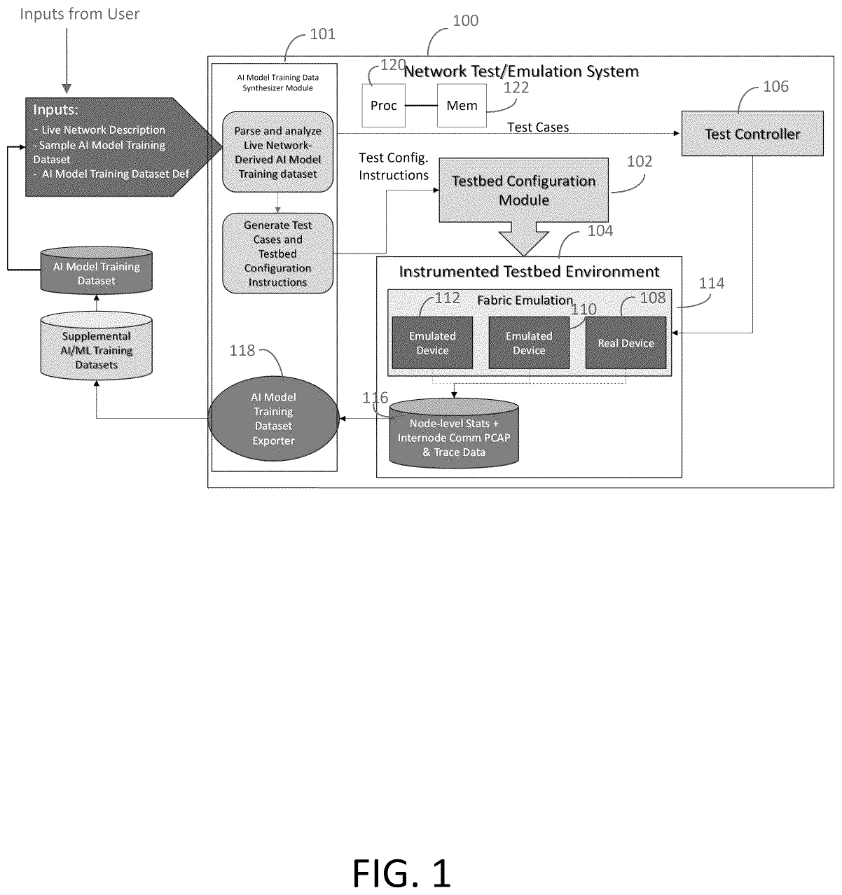

The subject matter described herein is adapted to create and/or supplement data that can be used to train an AI model of a communications network environment (e.g., data center, WAN, 5G/6G mobile network, cloud computing environment, edge computing environment, etc.). FIG. 1 is a block diagram of a network test/emulation system for generating synthetic AI-implemented computer network behavioral model training data in response to user input including sample model training data or a model training data definition. Referring to FIG. 1, a network test/emulation system 100 includes an AI model training data synthesizer module 101 that receives, as input, a network description, which may include network topology information (e.g., numbers and types of network elements), and a sample AI model training dataset. In an alternate example, instead of receiving a sample Al model training dataset, AI model training data synthesizer module 101 may receive as input, a data definition, e.g., a data structure, containing types of attributes, AI model parameters or dimensions that can be used in the Al training data. AI model training data synthesizer module 101 analyzes the sample AI-implemented model training data or definition, generates an AI-implemented model training data generation/supplementation plan, generates a test plan to generate the type of AI-implemented model training data indicated by the sample data or the data definition, and provides the test plan to a testbed configuration module 102. Testbed configuration module 102 receives, as input, the test plan, uses the test plan to configure components of an instrumented testbed environment 104 according to a desired network topology for implementing the test, and provides test execution instructions to a test controller 106. Instrumented testbed environment 104 may include real devices 108 and emulated devices 110 and 112, which, in the illustrated example, are part of an emulated data center switching fabric 114. In one example, real devices 108 may be real (i.e., non-emulated) data storage units and/or switches used to store and switch data into and out of a data center. Emulated devices 110 and 112 may be nodes that emulate data center hardware, such as switches and storage units and/or software, such as operating systems and applications that run on real or emulated data center hardware.

Test controller 106 controls instrumented testbed environment 104 to execute the test or tests specified by the test plan. For example, if the sample AI-implemented model training data indicates a data center switching topology in which network traffic queue depths reach a certain level, test controller 106 may control a packet generator to send a volume and type of network traffic to instrumented testbed environment 104 to achieve the desired queue depths. One or more network data collectors may collect node level and/or network level statistics, packet capture (PCAP) data, flow record data, and other trace data 116 resulting from execution of the test and provide the data to an AI-implemented model training data exporter 118. AI-implemented model training data exporter 118 transforms the network data into a format expected by the AI-implemented computer network behavioral model and outputs the AI-implemented computer network behavioral model training data. Transforming the collected data from the network test into the desired format may include adding records, adding attributes, or adding both to an existing AI-implemented computer network behavioral model training dataset or training dataset definition. In some contemplated embodiments, transforming the collected data may include processing collected raw data to derive a metric value that is then added as an AI model training data parameter. Adding the training data to the dataset or the dataset definition is referred to herein as inflating the training data. Because the training data is generated by a network other than a real production network the generated training data is referred to as synthetic training data.

Network test/emulation system 100 includes at least one processor 120 and a memory 122. AI model training data synthesizer module 101, test controller 106, and testbed configuration module 102 may be implemented using computer executable instructions stored in memory 122 and executed by processor 120.

As indicated above, inflation processing performed by network test/emulation system 100 may include the following three operations:
1. Dataset Record Inflation, where the network test/emulation system is adapted to analyze a sample of the user's existing Al model training dataset and to subsequently configure the network test/emulation system resources (e.g., hardware and software emulators, real (non-emulated) hardware and software processing nodes, traffic generators, etc.) to generate additional records (with the same parameter structure as the existing training dataset or dataset definition) that can be added to the user's AI model training dataset, thereby inflating the number of entries/records in the Al model training dataset;
2. Dataset Parameter Inflation, where the test and emulation system is adapted to analyze a sample of the user's existing Al model training dataset and to subsequently configure the network test/emulation system resources (e.g., hardware and software emulators, non-emulated hardware and software processing nodes, traffic generators, etc.) to generate additional parameters for each existing record in the user's AI model training dataset or dataset definition, thereby inflating the number of parameters in the Al model training dataset; and
3. Dataset Scale Inflation, where the network test/emulation system is adapted to analyze a sample of the user's existing AI model training dataset or dataset definition along with user-specified scaling instructions and to subsequently configure the test/emulation system resources (e.g., hardware and software emulators, non-emulated hardware and software processing nodes, traffic generators, etc.) to generate additional records for an Al model training dataset, thereby inflating both the number of records and the number of parameters in the AI model training dataset.
   Examples of each of these types of inflation processing will now be described.

### Record Inflation

As used herein, the term “record inflation” refers to the generation of synthetic data records or entries by the network test/emulation system, which can be used to construct or supplement an AI-implemented computer network behavioral model training dataset.

A network test/emulation system user provides either an Al model training dataset definition (e.g., a structured list of parameters that make up each dataset entry/record) or a sample of an existing AI model training dataset (e.g., comma separated variable (csv) format, JSON format, extensible markup language (XML) format, etc.) as input. Such AI model training dataset information may include labeled and/or unlabeled data. In some examples, part of the input information provided by the user may include, but is not limited to, network topology information, network traffic information, network link configuration information, network congestion status information, network quality of service/quality of experience (QOS/QoE) information, network performance metric information, detailed network element configuration information, network element performance metric information, network user information, network protocol information, network services information, time-of-day/day-of-week level metrics and information.

An AI model training data synthesizer module is adapted to analyze the AI model training dataset information that is provided by the user and construct an AI model training data creation plan that includes one or more test that can be executed by the network test/emulation system. In some cases, the module may be capable of extracting/deriving network topology information directly from the provided AI model training dataset, while in other scenarios the user may provide AI model training dataset content and separately provide topology and network traffic information associated with the network from which the AI model training dataset content was captured.

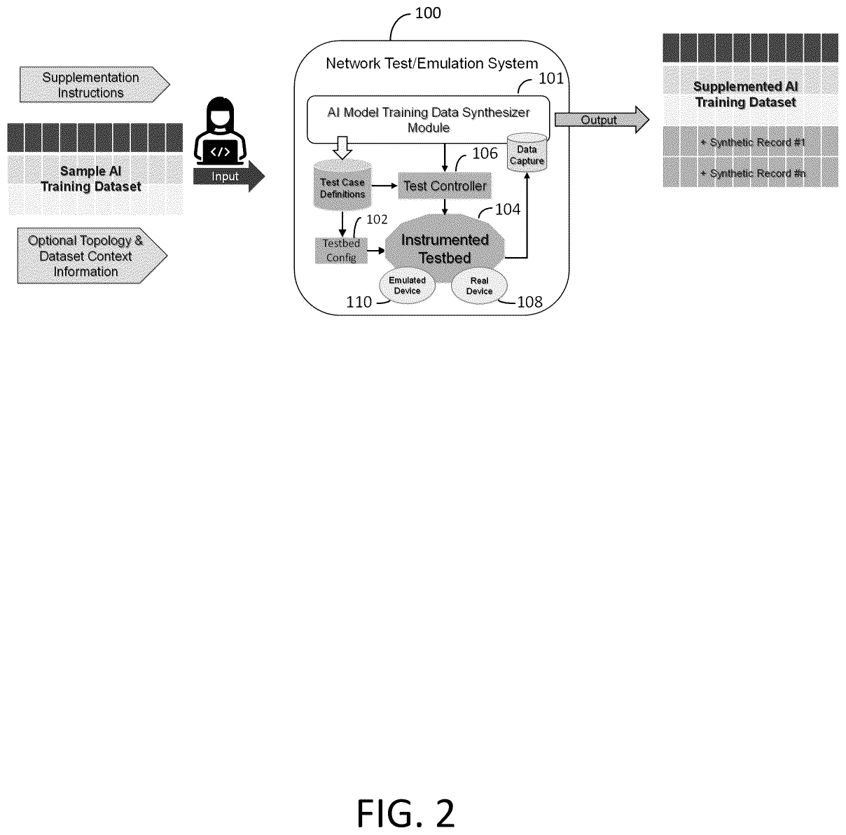

The operation of network test/emulation system 100 to perform AI-implemented computer network behavioral model training dataset record inflation is illustrated in FIG. 2. Referring to FIG. 2, AI model training data synthesizer module 101 receives, as input, a sample AI model training dataset, supplementation instructions, and topology and dataset context information. The sample AI model training dataset may be an Al model training dataset generated by a production network or manually by a user. For example, the sample AI model training dataset may include network traffic data collected in a production network or traffic conditions desired to be emulated. The supplementation instructions may also include traffic conditions desired to be emulated and the desired type of AI model training data inflation. In this case, it is assumed that the desired type of Al model training data inflation is dataset record inflation. The network topology information may include information, such as the number of nodes to be involved in a test, the types of nodes, and interconnections between the nodes. AI model training data synthesizer module 101 receives the input and generates, based on the input, test case definitions, which include the testbed configuration instructions provided to testbed configuration module 102 and the test cases, which are provided to test controller 106. Testbed configuration module 102 configures instrumented testbed environment 104 to include the desired types and arrangements of real devices 108 and emulated devices 110. It will again be appreciated that emulated devices 110 may include a mix of high- and low-fidelity emulation resources depending on the types of supplementation parameters needed. Test controller 106 controls instrumented testbed environment 104 to implement the tests. Al model training data synthesizer module 101 receives data captures resulting from the execution of the tests and generates and outputs synthetic training dataset records.

Test resources in instrumented testbed environment 104 may include a combination of real network elements and emulated network elements (e.g., switches, routers, gateways, load balancers, application servers, authentication servers, security/inspection servers, user terminals/mobile devices, endpoint terminals/devices, traffic generators, network visibility devices, etc.). Furthermore, emulated network elements may be instantiated using hardware and/or software emulations, where these emulations have varying degrees of emulation fidelity. In general, a low fidelity emulation mimics the high-level behaviors/performance of a network element (e.g., at one extreme of low fidelity, the network element is treated more as a black box, with no emulation or visibility into the low-level operational behaviors of the network element, e.g., CPU usage, memory usage, processing queue depth, internal signaling/messaging traffic, etc.), while a high fidelity emulation mimics both the high-level behaviors/performance of the network device and, to some degree, the inner workings of the network device, as well. A more detailed description and discussion of emulation fidelity may be found in commonly-assigned co-pending U.S. patent application Ser. No. 18/385,183, filed Oct. 30, 2023, the disclosure of which is incorporated herein by reference in its entirety.

During execution of the test case(s), network test/emulation system 100 runs test cases and captures data that corresponds to the types of data in the input sample training dataset(s) or dataset definitions that were previously generated, e.g., based on traffic observed/captured in a live network. In one example, the tests may include types or volumes of traffic that are different from the types or volumes of traffic that would typically be transmitted in a production network, e.g., due to operational or security risks.

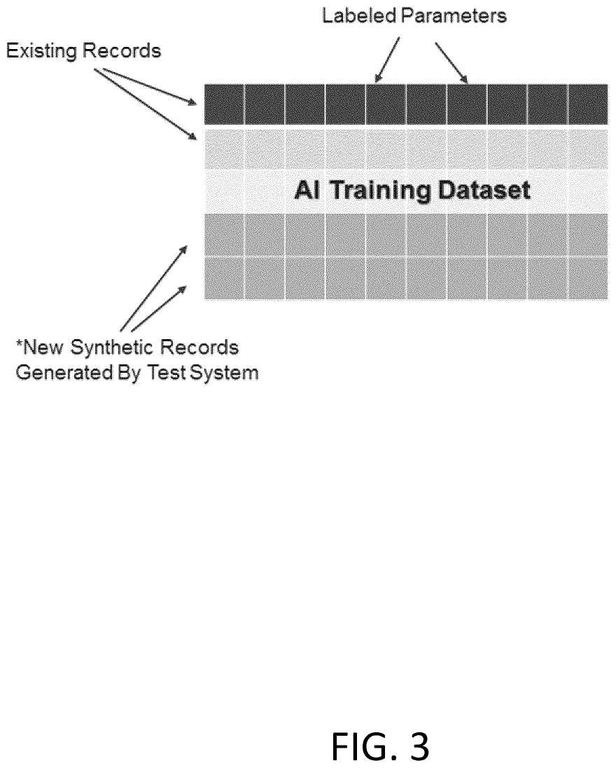

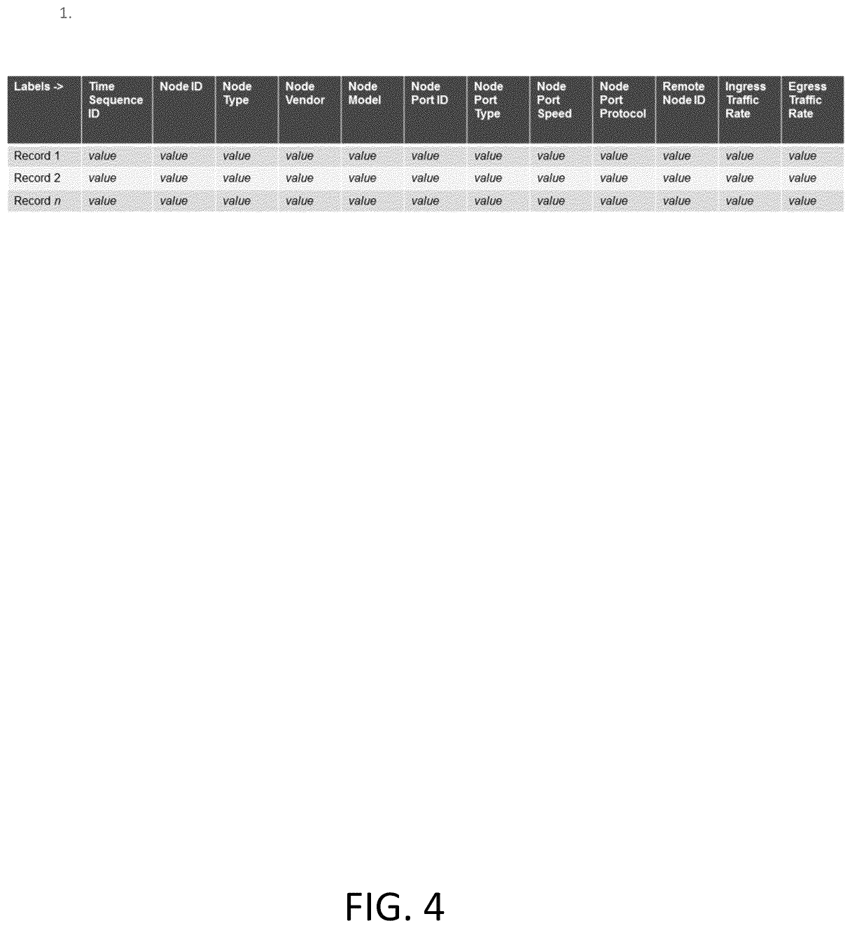

In one example, network test/emulation system 100 may generate and output synthetically generated training datasets that were identical/similar in format to live network-derived training dataset(s), as generally illustrated in FIGS. 3 and 4. In FIGS. 3 and 4, an existing AI model training dataset is shown in table format. Each row in the table corresponds to a dataset record, and each column in the table corresponds to a parameter in the dataset. Network test/emulation system 100 may perform dataset record inflation by adding records to an existing AI model training dataset or dataset definition, as shown by the synthetic records in FIG. 3. FIG. 4 illustrates example contents of a dataset for training an AI-implemented computer network behavioral model that may be provided as input to the AI model training data synthesizer described herein. In FIG. 4, the dataset parameters in each record include a time sequence ID, a node ID, a node type, a node vendor, a node model, a node port ID, a node port type, a node port speed, a remote node ID, an ingress traffic rate, and an egress traffic rate. Additional or other parameters may be included in a dataset record without departing from the scope of the subject matter described herein.

These synthetic training datasets can be labeled since the context in which the records are generated is known. The user can then add these synthetic training dataset records to canary or live network-derived training datasets and use the combined training datasets to train an AI-implemented computer network behavioral model.

In one use case scenario, the user could provide the test system with an empty or null AI model training set, which effectively only provides the test system with a network topology map/definition and a listing of desired Al model training parameters without providing AI model training data parameter values.

Running experiments in a canary network can produce intermediate results, of higher fidelity, which can be fed back into an AI-implemented computer network behavioral model to further refine the model. Further iterations can be performed in the emulated/hybrid setup provided by the network test/emulation system to conserve resources and allow experimentation and debugging. Refined tests can be submitted to the canary network again. This can be done as many times as required to obtain refined test plans and training data.

### Parameter Inflation

As used herein, the term “parameter inflation” refers to adding new parameters and parameter values to synthetic data records or entries that are created by network test/emulation system 100. The synthetically generated parameters and parameter values can be used to supplement the data in the existing AI model training dataset records or to replace, in part, existing records in the input AI model training dataset in their entirety.

A network test/emulation system user provides either an Al model training dataset definition (e.g., a list of parameters that make up each dataset entry/record) or a sample of an existing AI model training dataset (e.g., csv format, JSON format, spreadsheet format, etc.) as input. Such Al model training dataset information may include labeled and/or unlabeled data. In some examples, part of the input information provided by the user may include, but is not limited to, network topology information, network traffic information, network link configuration information, network congestion status information, network QoS/QoE information, network performance metric information, detailed network element configuration information, network element performance metric information, network user information, network protocol information, network services information, time-of-day/day-of-week level metrics and information. A user of network test/emulation system 100 may also provide a list of parameters with corresponding parameter labels that the user would like to add to an existing sample AI model training dataset.

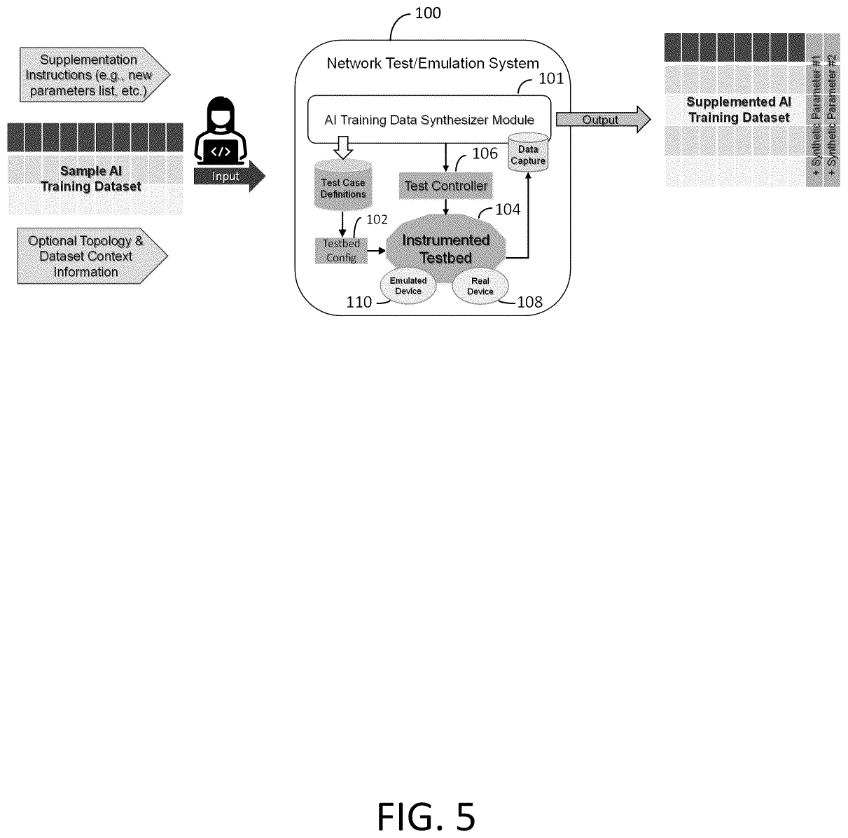

In FIG. 5, the network test/emulation system user provides a sample AI model training dataset, supplementation instructions, including new parameters that the user would like to add to the dataset, and network topology/context information to network test/emulation system 100. Al model training data synthesizer module 101 receives the input and generates one or more network test cases that will cause instrumented testbed environment 104 to execute one or more network tests that generate the requested parameters. AI model training data synthesizer module 101 captures or records data generated by instrumented testbed environment 104 during execution of the tests and outputs AI model training data with the additional parameters and parameter values requested by the user.

In another example, AI model training data synthesizer module 101 is adapted to analyze the AI model training dataset information that is provided by the user and construct an AI model training data creation plan including one or more network tests that can be executed by the test system, where the results of this analysis enable AI model training data synthesizer module 101 to automatically select or suggest additional parameters that should be collected/included in the AI model training dataset. In this type of use case scenario, AI model training data synthesizer module 101 may request and obtain additional input from the user regarding the desired/target functionality of the AI model that will be trained using this AI model training dataset. For example, if the user states that one desired/target functionality of the AI model being trained is to predict network congestion events, then AI model training data synthesizer module 101 may determine that switching/router ingress and egress processing queue parameters, such as queue depths and network traffic conditions required to produce congestion given the queue depths, should be added to the AI model training dataset. In addition, Al model training data synthesizer module 101 may specify in the AI model training data creation plan switch and router emulation test resources used in the associated test cases of sufficient fidelity to generate ingress and egress processing queue metric data, which is captured via testbed instrumentation and included in the supplemental AI model training data that is produced.

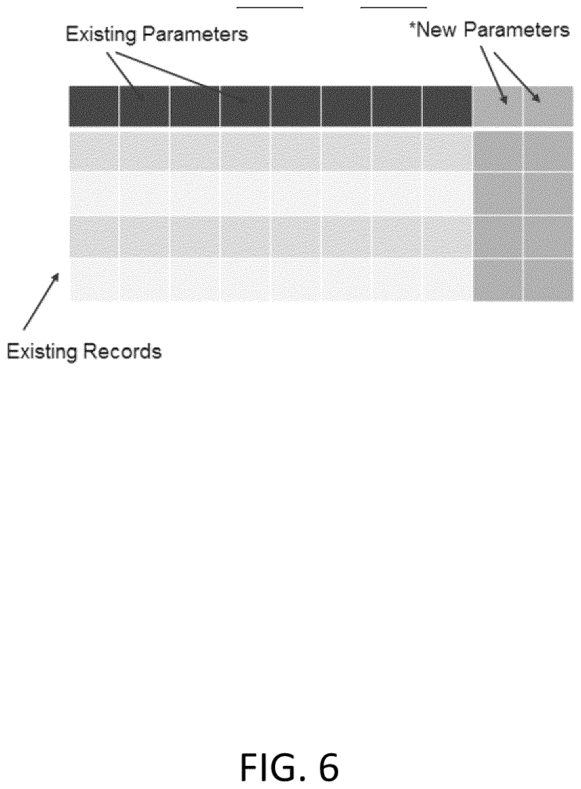

In one example, network test/emulation system 100 is adapted to receive input from a user which explicitly specifies or can be used to determine additional parameters that need to be added to an existing AI model training dataset. For example, a user may generate an AI model training dataset based on network configuration and operational data that was captured from the user's live network (or a canary network). This AI model training dataset may, for example, contain 1000 data samples/entries/records, each including 20 parameters. The user determines that the 20 parameters are insufficient to train an AI model having the desired performance characteristics. The user would like to supplement each of the 1000 records in this existing Al model training dataset with an additional 15 parameters. FIG. 6 illustrates the adding of parameters to an existing AI model training dataset. In FIG. 6, each row represents a database record, and each column represents a parameter. In this example, network test/emulation system 100 generates Al model training data that results in new parameters indicated by new columns added to the dataset records in FIG. 6.

Network test/emulation system 100 configures instrumented testbed environment 104, which is capable of replicating, at least in part, the network topology associated with the user's existing AI model training dataset. Furthermore, network test/emulation system 100 is adapted to configure the testbed resources (e.g., using variable fidelity emulations, etc.) and associated instrumentation to capture the additional 15 parameters. Network test/emulation system 100 executes 1000 test case runs, corresponding to the 1000 entries in the sample training dataset, and captures the additional 15 parameters. Network test/emulation system 100 then appends the additional 15 parameter values to the existing records in the user's AI model training dataset.

In another example, network test/emulation system 100 is adapted to synthetically generate data for all of the existing parameters in the sample/existing AI model training dataset, as well as to generate the new/additional 15 parameter values. In such a use case, network test/emulation system 100 is capable of effectively recreating a synthetic version of the input AI model training dataset sample, which further includes the new/additional 15 parameters and associated values.

### Scale Inflation

In another exemplary use case that is related to both record and parameter inflation, network test/emulation system 100 is adapted to emulate a scaled-up version of the network model used in the creation of the sample AI model training dataset. For example, a user may construct a small-scale model of a network in the user's lab/canary environment. Small call network models may be used in light of the costs associated with network modeling at scale.

The user provides network test/emulation system 100 with guidelines for scaling the network that is associated with the sample AI model training dataset. Such scaling guidelines may be high-level in nature, e.g., expand the switching fabric to include 5000 more switching nodes that are similar in type and connectivity to those that were used in the creation of the sample Al model training dataset, etc. In another example, the user may provide detailed topology scaling instructions, e.g., the user can provide a detailed scaled topology map/definition, which is interpreted and implemented by network test/emulation system 100.

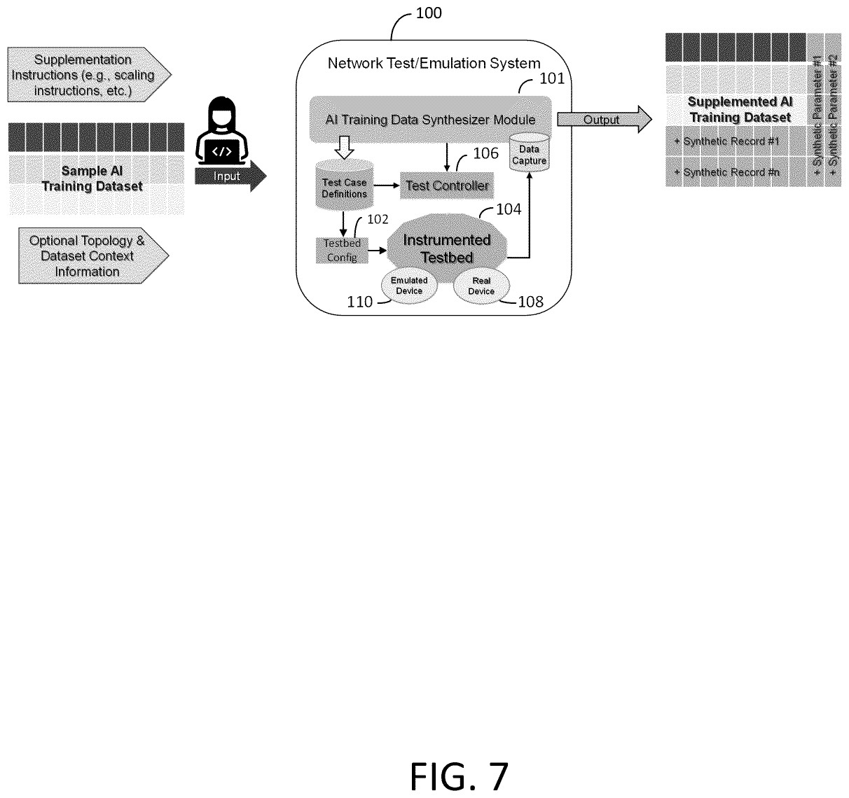

FIG. 7 illustrates the use of network test/emulation system 100 to generate AI model training data when the user provides scaling instructions as input. Referring to FIG. 7, a user provides a sample AI model training dataset, supplementation instructions, and topology and context information as input to network test/emulation system 100. The supplementation instructions include scaling instructions. In this example, it is assumed that the network topology information includes a network topology of a certain size, and the scaling instructions include instructions for scaling the network topology to generate AI model training data using the scaled network topology. AI model training data synthesizer module 101 receives the network topology information, the scaling instructions, and the sample AI model training dataset, and generates test cases that involve running tests using the scaled network topology. Test controller 106 controls instrumented testbed environment 104 to execute the tests. AI model training data synthesizer module 101 collects data generated by execution of the network tests and uses the data to generate AI model training data, which in the illustrated examples includes adding synthetic data records and synthetic data parameters to the AI model training dataset.

In the examples described herein where sample AI model training data is provided as input, network test/emulation system 100 may implement Al model training data tuning or calibration. AI model training data tuning or calibration involves comparing a synthetic AI model training dataset to an existing AI model training dataset, measuring an error between the synthetic AI model training dataset and the existing AI model training dataset, and rerunning the test with modified parameters to generate synthetic data that is more like the data in the existing AI model training dataset (when the goal is to generate training data that is similar to existing training data). It is understood that in some cases, the goal of AI model training data generation may be to generate AI model training data for anomalous network conditions in which the synthetic training data is intentionally different from the existing or sample AI model training data.

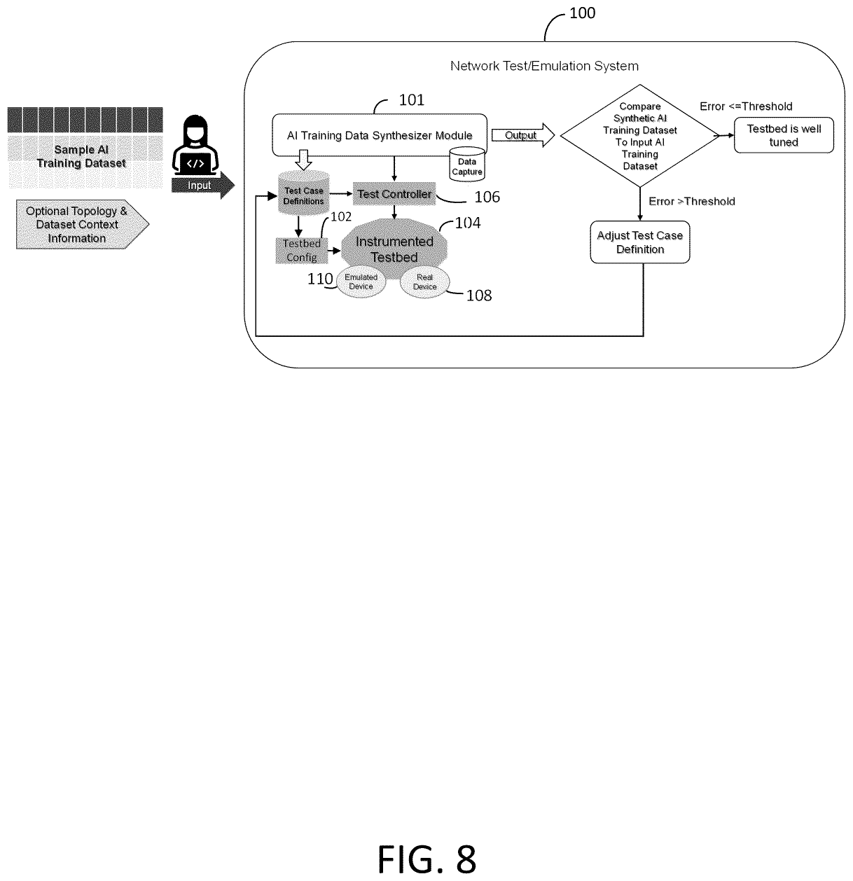

FIG. 8 illustrates the use of network test/emulation system 100 to generate synthetic AI model training data for the case where the goal is to generate AI model training data that is similar to existing AI model training data. Referring to FIG. 8, a user provides, as input, to network test/emulation system 100, a sample AI model training dataset, network topology information, and dataset context information. Network test/emulation system 100 receives the input, configures instrumented testbed environment 104 to execute one or more tests, executes the tests, collects data resulting from the execution of the tests, and outputs synthetic AI model training data. AI model training data synthesizer module 101 compares the synthetic Al model training data generated during the first test run to the sample Al model training data used as input and determines whether an error metric obtained from the comparison exceeds a threshold. If the error metric does not exceed the threshold, the two datasets are sufficiently similar, and AI model training data synthesizer module 101 outputs the synthetic training dataset as the final dataset to be used to train the AI-implemented computer network behavioral model. If the error exceeds the threshold, the two datasets are not sufficiently similar, and AI model training data synthesizer module 101 modifies the tests (e.g., adjusts the testbed configuration, adjusts the test traffic mix, etc.), runs the modified tests, outputs new AI model training data, and computes the error metric. This process is repeated until the error metric does not exceed the threshold, and the resulting synthetic Al network training data is output. In this way, network test/emulation system 100 can effectively auto-calibrate its test resource/testbed configuration to closely match/approximate a user's live or canary network prior to outputting the final synthetic AI model training data.

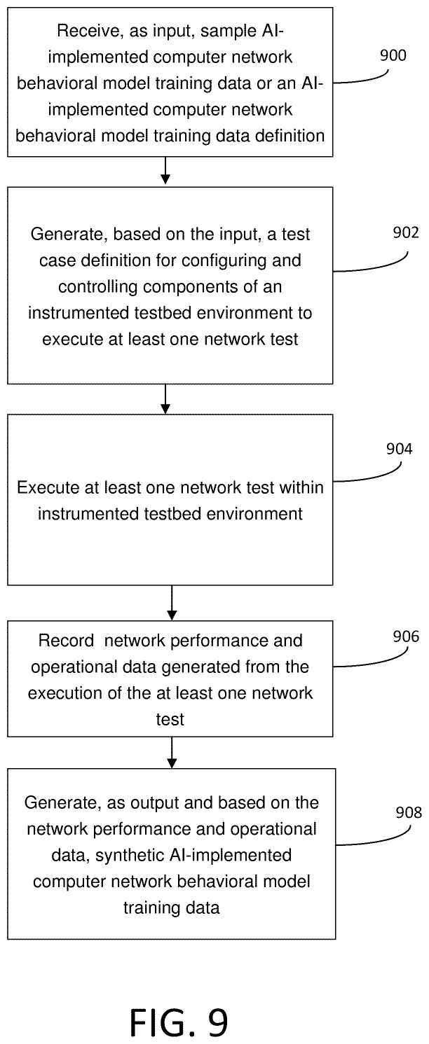

FIG. 9 is a flow chart illustrating an exemplary process for generating synthetic AI-implemented computer network behavioral model training data. Referring to FIG. 9, in step 900, the process includes receiving, as input, sample AI-implemented computer network behavioral model training data or an AI-implemented computer network behavioral model training data definition. For example, AI model training data synthesizer module 101 may receive sample AI model training data from a user's real or test network. In an alternate example, AI model training data synthesizer module 101 may receive a definition that defines the parameters and structure of the parameters of the AI model training data.

In step 902, the process further includes generating, based on the input, a test case definition for configuring and controlling components of an instrumented testbed environment to execute at least one network test. For example, AI model training data synthesizer module 101 may generate instructions for configuring non-emulated and/or emulated devices of instrumented testbed environment 104 to implement a desired network topology and execute at least one network test within the topology.

In step 904, the process further includes executing the at least one network test within the instrumented testbed environment. For example, instrumented testbed environment 104 may execute the test(s), which include transmitting network traffic between real and/or emulated network components.

In step 906, the process further includes recording network performance and operational data generated from the execution of the at least one network test. For example, instrumented testbed environment 104 may include network taps and/or other network visibility components that records operational data, performance data, and resulting from execution of the test(s).

In step 908, the process further includes generating, as output and based on the network performance and operational data, synthetic AI-implemented computer network behavioral model training data. In one example, the synthetic AI-implemented computer network behavioral model training data includes at least one parameter not included or defined in the AI-implemented computer network behavioral model training data or the AI-implemented computer network behavioral model training data definition, as illustrated by the parameter scaling examples described herein. The additional parameters may result from the testcase being executed by test system resources that operate at a higher level of fidelity than the resources used to produce the input training dataset. In addition to parameter inflation, AI model training data synthesizer module 101 may perform record inflation and/or scaling to generate and output the model training data.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for generating synthetic artificial intelligence (AI)-implemented computer network behavioral model training data, the method comprising:
receiving, as input, sample AI-implemented computer network behavioral model training data or an AI-implemented computer network behavioral model training data definition;
generating, based on the input, a test case definition for configuring and controlling components of an instrumented testbed environment to execute at least one network test;
executing the at least one network test within the instrumented testbed environment;
recording network performance and operational data generated from the execution of the at least one network test; and
generating, as output and based on the network performance and operational data, synthetic AI-implemented computer network behavioral model training data, wherein synthetic AI-implemented computer network behavioral model training data includes at least one parameter not included or defined in the AI-implemented computer network behavioral model training data or the AI-implemented computer network behavioral model training data definition.

2. The method of claim 1 wherein receiving, as input, sample AI-implemented computer network behavioral model training data or an AI-implemented computer network behavioral model training data definition includes receiving the sample AI-implemented computer network behavioral model training data as input.

3. The method of claim 1 wherein receiving, as input, sample AI-implemented computer network behavioral model training data or an AI-implemented computer network behavioral model training data definition includes receiving the AI-implemented computer network behavioral model training data definition as input.

4. The method of claim 1 wherein generating the test case definition includes generating instructions for configuring the components of the instrumented testbed environment to implement a network topology.

5. The method of claim 4 wherein executing the at least one network test includes transmitting network traffic within the network topology.

6. The method of claim 5 wherein recording the network performance and operational data includes recording network-traffic-related statistics resulting from the execution of the at least one network test and network conditions that resulted in the generation of the network-traffic-related statistics.

7. The method of claim 1 wherein generating the synthetic AI-implemented computer network behavioral model training data includes generating synthetic AI-implemented computer network behavioral model training dataset records.

8. The method of claim 2 comprising configuring the instrumented testbed environment to implement a network topology of a fidelity higher than a fidelity used to generate the sample AI-implemented computer network behavioral model training data.

9. The method of claim 1 comprising receiving, as input, scaling instructions and wherein generating the test case definition includes using the scaling instructions to generate a network topology of a desired scale within the instrumented testbed environment and executing the at least one network test includes executing the at least one network test in the network topology of the desired scale.

10. The method of claim 2 comprising computing an error metric indicating a difference between the synthetic AI-implemented computer network behavioral model training data and the sample AI-implemented computer network behavioral model training data, generating at least one updated network test in response to the error metric exceeding a threshold, executing the at least one updated network test within the instrumented testbed environment, recording network performance and operational data generated by the execution of the at least one updated network test; and generating, as output and based on the network performance and operational data, updated synthetic AI-implemented computer network behavioral model training data.

11. A system for generating synthetic artificial intelligence (AI)-implemented computer network behavioral model training data, the system comprising:
at least one processor and a memory;
an AI model training data synthesizer module implemented by the at least one processor for receiving, as input, sample AI-implemented computer network behavioral model training data or an AI-implemented computer network behavioral model training data definition and generating, based on the input, a test case definition for implementing and executing at least one network test; and
an instrumented testbed environment for executing the at least one network test and for recording network performance and operational data generated from the execution of the at least one network test, wherein the AI model training data synthesizer module is configured to generate, as output and based on the network performance and operational data, synthetic AI-implemented computer network behavioral model training data, wherein the synthetic AI-implemented computer network behavioral model training data includes at least one parameter not included or defined in the AI-implemented computer network behavioral model training data or the AI-implemented computer network behavioral model training data definition.

12. The system of claim 11 wherein the input includes the sample AI-implemented computer network behavioral model training data.

13. The system of claim 11 wherein the input includes the AI-implemented computer network behavioral model training data definition.

14. The system of claim 11 wherein, in generating the test case definition, the AI model training data synthesizer module is configured to generate instructions for configuring components of the instrumented testbed environment to implement a network topology.

15. The system of claim 14 wherein, in executing the at least one network test, the instrumented testbed environment is configured to transmit network traffic within the network topology and, in recording the network performance and operational data, the instrumented testbed environment is configured to record network-traffic-related statistics resulting from the execution of the at least one network test and network conditions that resulted in the generation of the network-traffic-related statistics.

16. The system of claim 11 wherein, in generating the synthetic AI-implemented computer network behavioral model training data, the Al model training data synthesizer module is configured to generate synthetic AI-implemented computer network behavioral model training dataset records.

17. The system of claim 12 wherein the instrumented testbed environment is configured to implement a network topology of a fidelity higher than a fidelity used to generate the sample AI-implemented computer network behavioral model training data.

18. The system of claim 11 wherein the AI model training data synthesizer module is configured to receive, as input, scaling instructions and, in generating the test case definition, the AI model training data synthesizer module is configured to use the scaling instructions to generate a network topology of a desired scale within the instrumented testbed environment and, in executing the at least one network test, the instrumented testbed environment is configured to execute the at least one network test in the network topology of the desired scale.

19. The system of claim 12 wherein:
the AI model training data synthesizer module is configured to compute an error metric indicating a difference between the synthetic AI-implemented computer network behavioral model training data and the sample Al computer network behavioral model training data, and generate at least one updated network test in response to the error metric exceeding a threshold;
the instrumented testbed environment is configured to execute the at least one updated network test and record network performance and operational data generated by the execution of the at least one updated network test; and
the AI model training data synthesizer module is configured to generate, as output and based on the network performance and operational data, updated synthetic AI-implemented computer network behavioral model training data.

20. A non-transitory computer readable medium having stored thereon executable instructions that when executed by a processor of a computer control the computer to perform steps comprising:
receiving, as input, sample artificial intelligence (AI)-implemented computer network behavioral model training data or an AI-implemented computer network behavioral model training data definition;
generating, based on the input, a test case definition for configuring and controlling components of an instrumented testbed environment to execute at least one network test;
executing the at least one network test within the instrumented testbed environment;
recording network performance and operational data generated from the execution of the at least one network test; and
generating, as output and based on the network performance and operational data, synthetic AI-implemented computer network behavioral model training data, wherein the synthetic AI-implemented computer network behavioral model training data includes at least one parameter not included or defined in the AI-implemented computer network behavioral model training data or the AI-implemented computer network behavioral model training data definition.
